(19) United States
(12) Patent Application Publication
(10) Pub. No.: US 2011/0258794 A1
(43) Pub. Date: Oct. 27, 2011

(54) MANUAL TOOTHBRUSH WITH POWER-DRIVEN SINGLE TUFT

(75) Inventors: Patrick A. Headstrom, Seattle, WA (US); Joseph W. Grez, North Bend, WA (US)

(73) Assignee: KONINKLIJKE PHILIPS ELECTRONICS N.V., EINDHOVEN (NL)

(21) Appl. No.: 13/142,008

(22) PCT Filed: Dec. 9, 2009
(86) PCT No.: PCT/IB2009/055608

§ 371 Date: Jun. 24, 2011

Related U.S. Application Data
(60) Provisional application No. 61/141,332, filed on Dec. 30, 2008.

(51) Int. Cl. A61C 17/32

(52) U.S. Cl. 15/22.2; 15/22.1

(57) ABSTRACT

The toothbrush in FIG. 1 includes a toothbrush body (12) and a brushhead assembly (14) which includes a manual field of bristle tufts (16) and a single/small plurality of bristle tufts (18) at a forward end of the manual field of bristles. The single bristle tuft or tufts is driven axially in the direction of the teeth, and is suitable for cleaning interproximal regions of the teeth.

This invention relates generally to toothbrushes, and more specifically concerns a toothbrush with a bristle field which has both manual and power driven portions.

A conventional manual toothbrush in which the bristle field is static and fixed to the brushhead, typically does not produce effective interproximal cleaning, i.e. cleaning of the interproximal regions between adjacent teeth. This is true even if the toothbrush has a bristle tip configuration which fits closely over adjacent teeth. Cleaning of teeth at the gum line is also typically not very good. Further, even when the bristles are configured to fit over adjacent teeth to provide more effective cleaning of the tooth surfaces covered by the brush, it is still often difficult for the user to determine the correct position of the toothbrush on the teeth to take advantage of the special bristle tip configuration.

Hence, it would be desirable to have a toothbrush with a bristle field which includes a conventional portion to accomplish scrubbing of the exposed surfaces of the teeth, but another portion which would be specifically adapted and effective for cleaning the interproximal and gum line regions and to assist in properly locating the brush on the teeth.

Accordingly, such a toothbrush comprises: a toothbrush body; a brushhead assembly which includes a manual bristle tuft field and a single additional bristle tuft or small plurality of bristle tufts; and a system for driving the single tuft or tufts toward and away from the brushhead assembly in the direction of the teeth of the user.

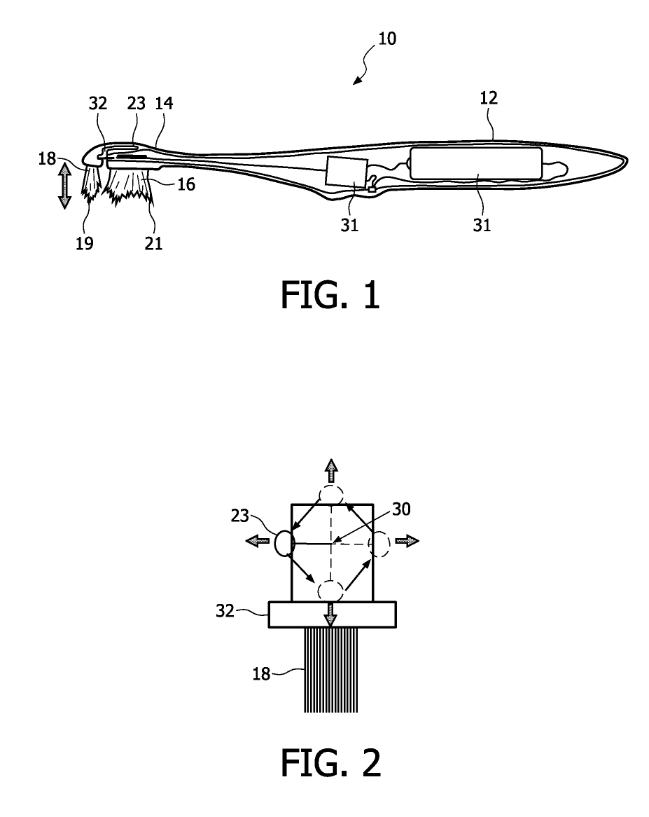

FIG. 1 is a simplified cross-sectional view of one embodiment of the new toothbrush.

FIG. 2 is an end view showing movement of the embodiment of FIG. 1.

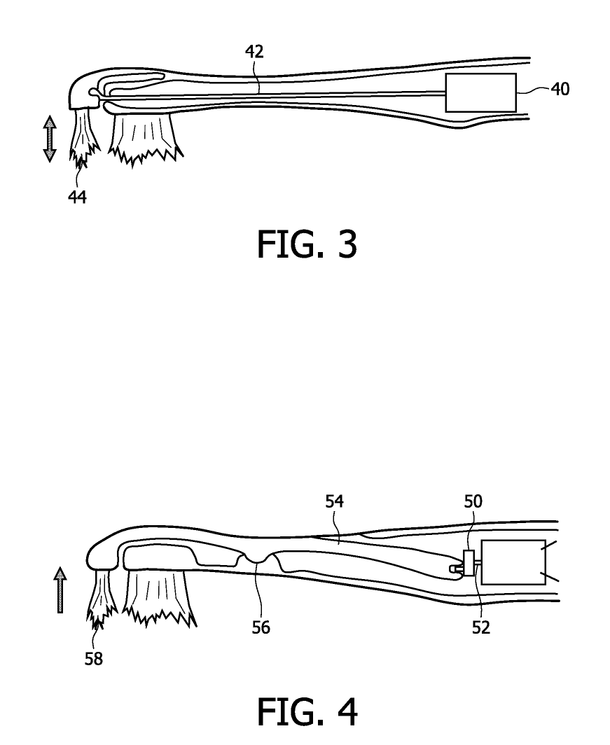

FIG. 3 is a simplified cross-sectional view of another embodiment using a crankshaft to drive a single tuft.

FIG. 4 is a simplified cross-sectional view of another embodiment using a yoke with an eccentric mounted pin.

Referring to FIG. 1, a toothbrush is shown generally at 10. The toothbrush 10 includes a body portion 12 and a brushhead portion 14. The brushhead portion includes a manual bristle field assembly 16 similar to a conventional manual toothbrush. The manual bristle field 16 is used to scrub the teeth in conventional fashion. The brushhead portion 14 also includes a driven tuft bristle field portion 18 which, in the embodiment shown, is a single tuft but could be a few tufts grouped together. Tuft 18 is power driven by a driving system, which is positioned within body portion 12 and which extends through the brushhead portion 14 to connect with the driven tuft 18.

A variety of driving systems can be used for the driven tuft 18, several embodiments of which are described below. Other driving systems in addition to those described are certainly possible, within the skill of the art. In the embodiment shown, the driven tuft 18 (or small group of driven tufts) can be positioned adjacent the forward end of the manual bristle field, adjacent the rear end of the manual bristle field, or it could be positioned within the bristle field itself.

The driven tuft 18 is generally conventional in size and other characteristics, including having approximately 30 bristles in the tuft. The bristle tufts as an example could be 1-1 ½ mm in diameter but could be larger or smaller. The tuft can be round or square in cross section or other shapes as well. The individual bristles in the tuft typically have a diameter of 0.006 inches and a length of approximately 0.40 inches and are made of nylon, although this could vary. The tips of the bristles in the tuft can be configured to a point or other arrangement so as to better fit into the interproximal and gum line areas of the dental region.

FIGS. 1 and 2 show an eccentric mass drive embodiment for the driven tuft, in which an eccentric element 23 moves in a circle about an axis of rotation 30 by a motor 31. The drive system of FIG. 1 includes a flat leaf spring 32 to which the bristle tuft is mounted. Flat spring 32 is configured to be significantly stiffer in the transverse direction than in the up/down direction, as shown by the arrows. This results in a primarily vertical motion of the driven tuft 18, i.e. a relatively small span of movement in the transverse direction and a large span of movement in the vertical or up/down direction. The action of the rotating motor shaft relative to the leaf spring is shown in FIG. 2 with a rotating mass 23, spring 32 and bristle tuft 18.

In the embodiment shown, the stroke of the tuft 18 is approximately 4 mm long. At the end of the stroke, however, the tips 19 of the tuft must extend sufficiently beyond the tips 21 of the manual bristles that the user can feel the axial motion (tapping) of the driven tuft 18 on their teeth. This axial motion, basically toward and away from the teeth, is effective for interproximal cleaning and also is useful for gum line cleaning Further, it can be effective for orienting the toothbrush relative to the position of the brushhead on the teeth. The tuft 18 can be positioned relative to the manual bristle field so that when the toothbrush is positioned so that tuft 18 hits the interproximal areas, which can be readily felt by the user, the manual bristle field is in a proper position to scrub the outside surfaces of two adjacent teeth. The manual toothbrush bristle field further can have the tips of its bristles configured to fit around two adjacent teeth.

FIG. 3 shows another embodiment of the drive system, in which a motor 40 drives a crankshaft 42, at the end of which is mounted a single driven tuft or tufts 44 to accomplish the interproximal cleaning The crankshaft 42 produces the axial motion for the tuft.

FIG. 4 shows a further embodiment which includes a motor 49 and an eccentric pin 50 on a motor shaft 52, the pin driving a yoke 54 vertically as shown by the arrows. Yoke 54 is mounted to a pivot 56 so that the action produces an axial movement of the single tuft 58.

The embodiments of FIGS. 1-4 are intended to show a variety of arrangements for producing a simple axial motion of single tufts. It should be understood that other, similar driving systems can be used to produce the desired axial motion of the single tuft.

Although a preferred embodiment and alternate embodiments of the invention have been disclosed for purposes of illustration, it should be understood that various changes, modifications and substitutions may be incorporated in the embodiment without departing from the spirit of the invention, which is defined by the claims which follow.

1. A toothbrush, comprising
a toothbrush body (12);
a brushhead assembly (14) which includes a manual bristle tuft field (16) and a single additional bristle tuft or small plurality of bristle tufts (18); and
a system for driving the single tuft or tufts toward and away from the brushhead assembly in the direction of the teeth of the user.

2. The toothbrush of claim 1, wherein the driven tuft or tufts are located at a forward or rear end of the manual bristle tuft field.

3. The toothbrush of claim 1, wherein the driven tuft or tufts are driven through a stroke of 1-4 mm, and wherein the tips (19) of the driven tuft or tufts extend beyond the manual bristle tuft field at the end of the drive tuft stroke.

4. The toothbrush of claim 1, wherein the driving system includes a motor (31) having a rotating shaft with an eccentric (23) mounted therein, the eccentric connected to a leaf spring (32) to which is mounted the drive tuft or tufts, wherein the leaf spring is significantly stiffer in the transverse direction than in the vertical direction, thereby producing a substantially straight axial motion of the driver tuft or tufts.

5. The toothbrush of claim 1, wherein the driving system includes a motor (40) with a rotating drive shaft, and a crankshaft (42) which is connected to and extends from the drive shaft, wherein the driven tuft or tufts are mounted to the crankshaft such that rotation of the motor results in an axial movement of the driven tuft or tufts toward and away from the brushhead assembly in the direction of the teeth.

6. The toothbrush of claim 1, wherein the driving system includes a motor (49) having a rotating drive shaft (52), and an eccentric pin (50) mounted on the drive shaft, the driving system further including a yoke assembly (54), driven by the eccentric pin, and a pivot (56) to which the yoke is mounted, the driven tuft or tufts being mounted to a distal end of the yoke such that a rotation of the motor drive shaft results in an axial motion of the driven tuft or tufts.

7. The toothbrush of claim 1, wherein the tips of the manual field of bristles is configured to generally match the shape of two adjacent teeth.
